(19) United States
(12) Patent Application Publication
(10) Pub. No.: US 2009/0090280 A1
(43) Pub. Date: Apr. 9, 2009

(54) STACKABLE PALLET ASSEMBLY AND METHOD OF ASSEMBLY AND USE THEREOF

(75) Inventor: Charles D. Mills, Chesterfield, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: TITAN TUBE FABRICATORS, INC., St. Louis, MO (US)

(21) Appl. No.: 12/098,163

(22) Filed: Apr. 4, 2008

Related U.S. Application Data
(60) Provisional application No. 60/910,071, filed on Apr. 4, 2007.

(51) Int. Cl. B65D 19/38; B65D 19/28; B23P 11/00; B65G 57/00; B65D 21/02

(52) U.S. Cl. 108/53.1; 29/428; 414/802

(57) ABSTRACT

A pallet assembly for use with a stacking frame includes an upper deck for receiving material to be held by the pallet assembly. The upper deck defines two opposing edges and two opposing ends with the two ends of the upper deck includes at least one notch along a lower edge dimensioned for receiving a toe of a stacking frame positioned above the upper deck. A plurality of stringers extend a length of the upper deck, each stringer having an elongated body with two ends, a central portion, an upper surface, a lower surface, and a notch along the lower surface about the central portion. The stringers include an edge stringer on each of the two opposing edges of the upper deck and two intermediate stringers positioned apart and on opposing sides of a midpoint between the two edges. A support member is positioned beneath the upper deck between the two intermediate stringers and an end of the upper deck. The support member has a column extending upwardly for engaging a portion of the upper deck and a notch along a bottom surface.

### CROSS-REFERENCE TO RELATED APPLICATIONS

This application claims priority to U.S. Provisional Application No. 60/910,071 filed Apr. 4, 2007, the disclosure of which patent applications are incorporated herein by reference.

### FIELD

The present disclosure relates to pallets and, more specifically, to a pallet assembly for stacking with a stacking frame.

### BACKGROUND

The statements in this section merely provide background information related to the present disclosure and may not constitute prior art.

Pallets are well known in the transportation and stored industries. Pallets are generally composed of wood or metal. A plurality of deck members form an upper deck on which storage components are placed. Stringer members are positioned beneath the deck members and perpendicular to the deck members. Additional deck members can also be used beneath the stringer members to form a bottom deck. The stringer members create a gap between the upper deck and the lower deck in which a fork from a lifting device can be inserted for lifting and moving the pallet assembly.

While it is typical to stack a pallet on top of another pallet, this is undesirable where the contents of the lower pallet cannot support the weight placed on it. Stacking frames can be positioned onto a pallet to enable one pallet to be stacked on top of another pallet without having to stack the upper pallet onto the articles stored on the lower pallet. These stacking frames generally are attached to a wood or metal pallet such that the weight of the stacking frame and any upper pallet and its contents placed thereon are transferred from the upper pallet through the stacking frame to the upper deck of the lower pallet. However, this additional weight can be substantial and cause a failure in the lower pallet on which the stacking frame is attached, thereby causing the stacked frame and the pallet and its contents placed on the stacked frame to lean or fail. This can cause considerable safety and maintenance problems and is undesirable.

### SUMMARY

Recognizing the needs and problems associated with current pallet designs, the inventors hereof have succeeded at designing pallet assembly that can improve the safety and operation of stacked pallets and the storage of contents placed thereon. The pallet assemblies as described herein provide for securing of a wide variety of pallet stacking frames on a pallet assembly that provide for improved support for stacking frames and the weight carried by such stacking frames. Some embodiments of the disclosure provide for a transfer of weight from an upper stacking frame to a lower stacking frame without an intervening deck board or upper deck portion of the pallet assembly having to support and transfer the weight. Additionally, embodiments of the disclosure also provide for improved anti-slipping and anti-sliding coupling between a lower stacking frame and the pallet and between an upper stacking frame and the pallet.

According to one aspect, a pallet assembly for use with a stacking frame has an upper deck for receiving material to be held by the pallet assembly. The upper deck defines two opposing edges and two opposing ends with the two ends of the upper deck including at least one notch along a lower edge dimensioned for receiving a toe of a stacking frame positioned above the upper deck. A plurality of stringers extend a length of the upper deck, each stringer having an elongated body with two ends, a central portion, an upper surface, a lower surface, and a notch along the lower surface about the central portion. The stringers include an edge stringer on each of the two opposing edges of the upper deck and two intermediate stringers positioned apart and on opposing sides of a midpoint between the two edges. A support member is positioned beneath the upper deck between the two intermediate stringers and an end of the upper deck. The support member has a column extending upwardly for engaging a portion of the upper deck and a notch along a bottom surface.

According to another aspect, a method of assembling a pallet includes forming a plurality of upper deck boards from metal c-channel and cutting two notches on a lower edge proximate to the center of two of the upper deck boards to form two end deck boards, the two notches being separated by an intervening portion. The method also includes forming a plurality of stringers from metal box-channel and cutting a notch in each stringer on a lower surface of each stringer and includes two edge stringers and two intermediate stringers. The method further includes forming two support members from metal box-channel and forming an upwardly extending column proximate to a center of each support member and cutting a notch on the bottom surface of each support member. Each upper deck board is placed parallel to each other and each stringer is placed perpendicular to each upper deck board with an edge stringer positioned at each end of each deck board and the two intermediate stringers positioned on opposing sides of a middle of each deck board. Each stringer is welded to each upper deck board. Each support member is welded proximate to each end of the intermediate stringers and each column of each support member is welded to the two intervening portions between the two notches on the lower edge of the two end deck boards.

According to yet another aspect, a method of stacking a plurality of pallets using stacking frames includes placing a first pallet assembly on a floor. The first pallet assembly has an upper deck with a plurality of deck boards includes two coupling deck boards, a plurality of stringers extending a length of the upper deck with each stringer having an elongated body with two ends, a central portion, an upper surface, a lower surface, and a notch along the lower surface about the central portion. The stringers include an edge stringer on each of the two opposing edges of the upper deck and two intermediate stringers positioned apart and on opposing sides of a midpoint between the two edges. Two support members are positioned beneath each end of the upper deck and between the two intermediate stringers with each support member having a column extending upwardly for engaging a portion of the upper deck and a notch along a bottom surface. The method also includes assembling a stacking frame on the first pallet assembly with each leg of the stacking frame being positioned proximate to a center of each edge and each end of the first pallet. This includes inserting a toe of two of the footplates of the stacking frame into a notch on the lower edge of the ends of the upper deck and engaging a toe of two of the other footplates of the stacking frame under a coupling deck board of the upper deck of the first pallet assembly. The method further includes placing a second pallet assembly onto an upper portion of the stacking frame that is assembled on the first pallet assembly. The second pallet assembly being the same as the first pallet assembly. A first upper portion of the stacking frame is positioned into the notches in the bottom of the two support members and a second upper portion is positioned into the notches on the lower surface of the stringers.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a top perspective view of a pallet assembly according to one exemplary embodiment.

FIG. 2A is a top view of the pallet assembly of FIG. 1.

FIG. 2B is an end view of the pallet assembly of FIGS. 1 and 2A.

FIG. 2C is a side or edge view of the pallet assembly of FIGS. 1, 2A, and 2B.

FIGS. 3A and 3B are side and end views, respectively, for a stringer according to one exemplary embodiment of a pallet assembly.

FIGS. 4A and 4B are side and end views, respectively, for an end deck board according to one exemplary embodiment of a pallet assembly.

FIGS. 5A and 5B are side and end views, respectively, for a support anti-slip member according to one exemplary embodiment of a pallet assembly.

FIG. 6 is a perspective view of a support member of pallet assembly with an upper stacking frame positioned above the pallet assembly and a lower stacking frame positioned below the pallet assembly.

FIG. 7 is a perspective view of a pallet assembly showing the support member positioned on top of an upper portion of a lower stacking frame according to another exemplary embodiment.

FIG. 8 is a side perspective view of a stringer and notch in the stringer with an upper stacking frame positioned on the upper deck and a lower stacking frame positioned in the notch of the stringer according to another exemplary embodiment.

FIG. 9 is a top perspective view of a connection between a leg and toe of an upper stacking frame to the coupling deck boards of a pallet assembly according to some embodiments.

It should be understood that throughout the drawings, corresponding reference numerals and/or text indicate like or corresponding parts and features.

### DETAILED DESCRIPTION

The following description is merely exemplary in nature and is not intended to limit the present disclosure or the disclosure's applications or uses.

In some embodiments, a pallet assembly for use with a stacking frame include an upper deck for receiving material to be held by the pallet assembly. The upper deck defines two opposing edges and two opposing ends with the two ends of the upper deck including at least one notch along a lower edge dimensioned for receiving a toe of a footplate of a stacking frame positioned above the upper deck. A plurality of stringers extend a length of the upper deck, each stringer having an elongated body with two ends, a central portion, an upper surface, a lower surface, and a notch along the lower surface about the central portion. The stringer can be solid stringers or can include fork notches for receiving a fork from a lifting device. The notches along the lower surface of the stringers can be dimensioned for receiving a second upper portion of the stacking frame positioned below the pallet assembly. The notches in the stringers can also form a channel for receiving the second upper portion of the stacking frame between the two edges of the upper deck. In some embodiments, the notches on the stringers can be configured for restricting or preventing movement or slippage between the stringer and the upper portion of the stacking frame on which it is mounted. This can include one or more interlocking features or surface treatments that can provide such anti-slipping capability. Such anti-slipping features can be general in nature or design or can be adapted for particular stacking frames.

The stringers include an edge stringer on each of the two opposing edges of the upper deck and two intermediate stringers positioned apart and on opposing sides of a midpoint between the two edges.

A support member is positioned beneath the upper deck between the two intermediate stringers and an end of the upper deck. The support member has a column extending upwardly for engaging a portion of the upper deck and a notch along a bottom surface. The notch of the support member can be dimensioned for receiving an upper portion of a stacking frame positioned below the pallet assembly. The support member can be configured to prevent and/or restrict movement or slippage between the support member and its pallet and the upper portion of the stacking frame on which it is mounted. This can include one or more interlocking features or surface treatments that can provide for anti-slipping functionality. Such anti-slipping features can be general in nature or design or can be adapted for particular stacking frames. In such embodiments, the support member can provide for a more stable stacking of pallets, such as to form tiers, and a safer environment for workers and less spoilage that can result from toppled pallets. This can include restricting or limiting slippage during static placement of the tiered pallets in a warehouse truck or otherwise and can also provide for the ability for moving a tier of pallets via a fork lift or other lifting and moving device.

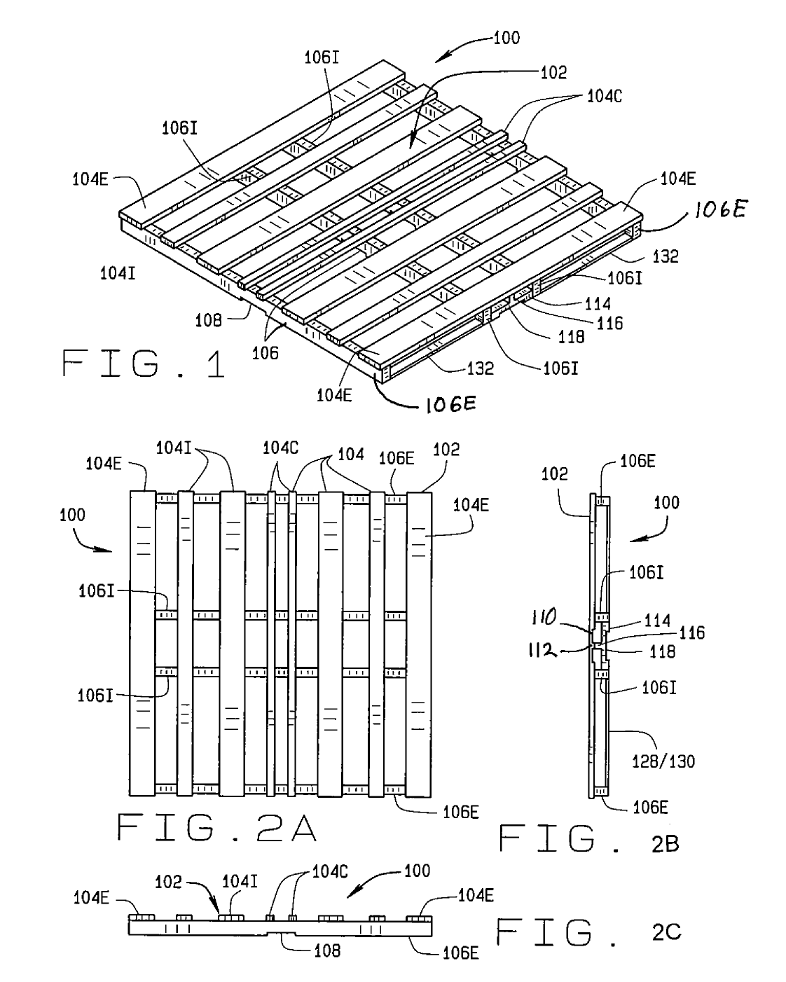

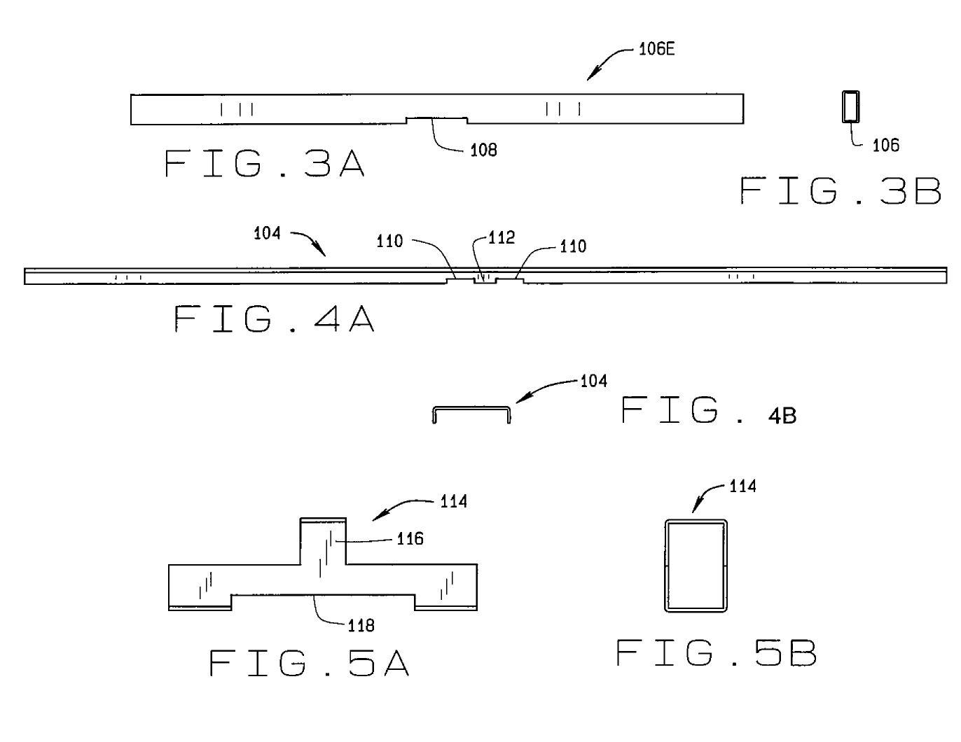

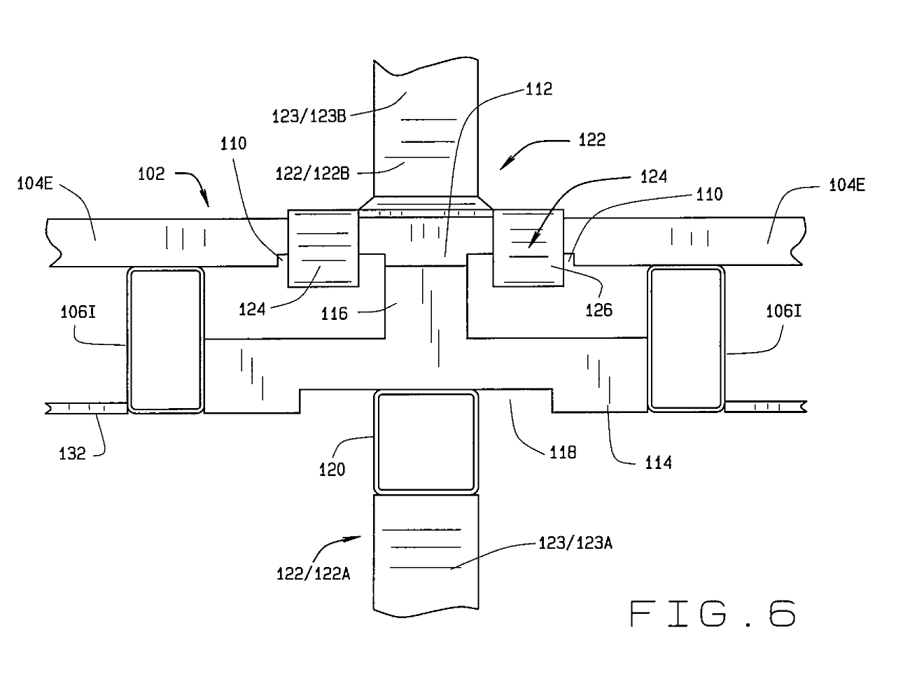

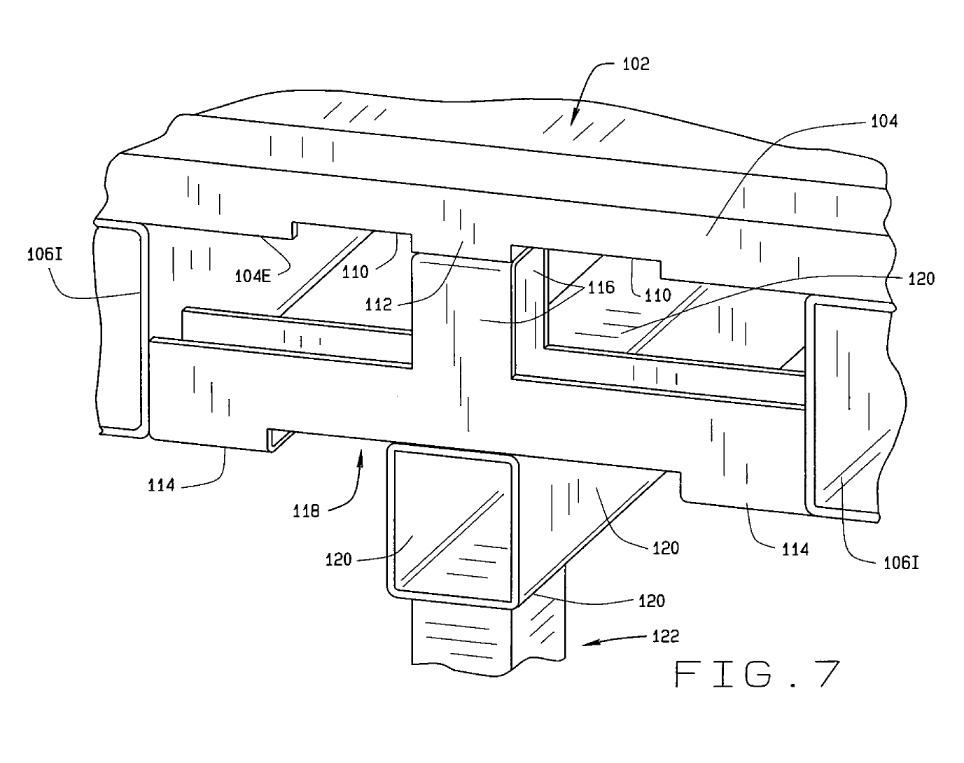

One embodiment of a pallet assembly 100 is illustrated in FIGS. 1, 2A, 2B, and 2C. Examples of individual components of the pallet assembly 100 are illustrated in FIGS. 3A, 3B, 4A, 4B, 5A, and 5B along with one exemplary set of dimensions that may be suitable for some applications. FIGS. 6-9 provide additional details for various portions of the pallet assemblies 100 of FIGS. 1, 2A, 2B, and 2C.

As shown in the figures, the pallet assembly 100 includes an upper deck 102 having one or more deck boards 104 forming a top, a bottom, two sides and two opposing ends of the upper deck 102, a plurality of stringers 106 attached to the bottom of the upper deck 102 traversing between the two ends of the upper deck 102. The upper deck 102 can be composed of a single unitary body having a single deck board 104 or can have a plurality of deck boards 104. For example, as shown in FIGS. 1, 2A and 2C, the upper deck 102 can be composed of an end deck board 104E on each end, two coupling deck boards 104C positioned proximate to a notch 108 of one of the stringers 106, and one or more intermediate deck boards 104I positioned parallel to each other and perpendicular to the stringers 106 to form the upper deck 102. In such embodiments, each end deck board 104E, or all deck boards 104, can include at least one notch 110 and in some embodiments, includes a pair of notches 110 spaced apart by an intervening portion 112, each of such notches 110 generally being formed at least on the bottom portion of the deck board 104. The pallet assembly 100 can also include one or more support members 114. The support member 114 can include a center column 116 that is engaged with or coupled to the intervening portion 112 and positioned between the pair of notches 110 of the end deck board 104E for providing vertical structural support.

As shown in more detail in FIGS. 6-10, the notches 110 are configured for supporting the coupling to a pallet stacking frame 122 having an upper portion 120 and one or more legs 123, each leg 123 having a foot 124. The foot 124 of the stacking frame 122 can also include one or more toes 126. For example, as shown in FIG. 6, the pair of notches 110 can be configured to receive a pair of toes 126 of a foot 124 of a pallet stacking frame 122 so that the stacking frame 122 is at least partially secured to the pallet assembly 100 by its foot 124 and toe 126 arrangement. Additionally, the support member 114 can also have a notch 118 on its lower end or bottom for receiving an upper portion 120 of a lower stacking frame 122 upon which the pallet assembly 100 is mounted.

Multiple deck boards 104 composing the upper deck 102 can be of various widths for support the stored material on the pallet assembly 100. In some embodiments, the coupling deck boards 104C have a width less than a width of the end deck boards 104E and are positioned on opposing sides of a centerline between two opposing stringers 106. In this manner, the coupling deck boards 104C can be configured to support the foot 124 of a stacking frame 122 and receive and partially engage a toe 126 of the stacking frame foot 124 for at least partially securing the foot 124 of the stacking frame 122 to the upper deck 102.

In some embodiments, there are two support members 114 with one positioned on each end of the upper deck 102. In such embodiments, the notches 118 of the two support members 114 form an unobstructed channel from one end to the other end.

Additionally, in some embodiment, a lower deck 128 as shown in FIG. 2B can have one or more deck boards 130 is positioned beneath and parallel to the upper deck 102 on opposing sides and is also attached to the stringers 106. The lower deck 128 can be configured to not obstruct the channel formed by the notches 118 of the two support members 114. In an alternative embodiment, a lower end member 132 is positioned on each end with each lower end member 132 being attached to one of the stringers 106 along an edge of the pallet assembly 100 and possibly one or more of the stringers 106 that are intermediate between the edges. Additionally, in some embodiments lower deck boards 130 can be welded or otherwise attached flush with a bottom surface of the stringers 106. In such embodiments, such a flush lower surface can provide or facilitate movement of the pallet in a working environment, including a roller conveyor, while minimizing or eliminating the pallet assembly 100 from interference from foreign objects or components of the operating environment.

The upper deck 102, stringers 106 and the support member 114 can each be composed of a wood or a metal or a composite material. In one preferred embodiment, each is composed of a metal such as steel and is attached to another component by one or more welds of any type suitable method for coupling two metal components together. Other methods are also possible including fixedly coupling one or more of the components of a pallet assembly 100 together with fasteners or adhesives.

When they are composed of metal, in one embodiment the stringers 106 and the support members 114 are configured from metal box channels that are cut as described above and again below. The upper deck can be configured from c-channel or a box channel and cut according to that described above and below.

Generally, the support members 114 are configured to transfer weight from the ends of the stacking frame 122 positioned in the notch 110 of the upper deck 102 or deck boards 104 through the support member 114 to the upper portion 120 of a lower stacking frame 122 positioned below the assembly or to the stringers 106 and thereafter to a structure or working surface on which the pallet assembly 100 is positioned. In operation, it can be desired, especially in multiple pallet stacking arrangements, that the support members 114 and the stringers 106 transfer the weight from an upper stacking frame 122 positioned on top of the pallet assembly 100 substantially or directly to a second lower stacking frame 122 positioned below the pallet assembly 100, e.g., without having the upper deck 102 of the pallet assembly 100 having to receive or be required to support any of the weight associated with the upper stacking frame 122.

Pallet assemblies 100 as described herein by exemplary embodiments can be manufactured by a variety of methods as known to those skilled in the art from reviewing the above disclosure. In one embodiment, a method of manufacturing and/or assembling a pallet assembly 100 includes forming a plurality of upper deck boards 104 from metal c-channel and cutting two notches 110 on a lower edge proximate to the center of two of the upper deck boards 104 to form two end deck boards 104E, the two notches 110 being separated by an intervening portion 112. One exemplary embodiment is illustrated in FIGS. 4A and 4B. The method also includes forming a plurality of stringers 106 from metal box-channel including cutting a notch 108 in each stringer 106 on a lower surface. In some embodiment, at least two edge stringers 106E and two intermediate stringers 106I are formed for the pallet assembly 100. One example of such formed stringers 106 is shown in FIGS. 3A and 3B.

The method further includes forming two support members 114 from metal box-channel including forming an upwardly extending column 116 proximate to a center of each support member 114 and cutting a notch 118 on the bottom surface of each support member 114. An example of a support member 114 is illustrated in FIGS. 5A and 5B. As noted above, the notch 118 in the support member 114 can be configured to couple with the upper portion of a stacking frame so that slippage between the two is minimized and/or eliminated. Various alternative variations of designs of such notch 118 and support member 114, not illustrated in the exemplary embodiment of FIGS. 5A and 5B are also considered to be within the scope of the present disclosure.

Each upper deck board 104 can be placed substantially parallel to each other and each stringer 106 can be placed substantially perpendicular to each upper deck board 104 with an edge stringer 106E positioned at each end of each deck board 104 and the two intermediate stringers 106I positioned on opposing sides of a middle of each deck board 104. Each stringer 106 can be welded to one or more of the upper deck boards 104. Each support member 114 is welded proximate to each end of the intermediate stringers 106I and each column 116 of each support member 114 is welded to the two intervening portions 112 between the two notches 110 on the lower edge of the two end deck boards 104E. An example of this embodiment is illustrated in FIGS. 6 and 7.

A lower end member 132 or lower deck board 130 can also be welded at each end of the pallet assembly 100 such as between each edge stringer 106E and an adjacent intermediate stringer 106I as may be desired in some embodiments for added structural support and for defining preferred lower deck 128 of the pallet assembly 100.

In operation, various embodiments of the pallet assemblies 100 as described herein can be used with stacking frames 122 for vertically stacking pallet assemblies 100 and their contents on top of another pallet assembly 100. One embodiment of a method of stacking a plurality of pallet assemblies 100 includes using stacking frames 122. A first pallet assembly 100 is placed on a floor or working surface. The first pallet assembly 100 has an upper deck 102 with a plurality of deck boards 104 including two coupling deck boards 104C, a plurality of stringers 106 extending a length of the upper deck 102 with each stringer 106 having an elongated body with two ends, a central portion, an upper surface, a lower surface, and a notch 108 along the lower surface about the central portion. The stringers 106 include an edge stringer 106E on each the two opposing edges of the upper deck 102 and two intermediate stringers 106I positioned apart and on opposing sides of a midpoint between the two edges. Two support members 114 are positioned beneath each end of the upper deck 102 and between the two intermediate stringers 106I with each support member 114 having a column 116 extending upwardly for engaging a portion of the upper deck 102 and a notch 118 along a bottom surface.

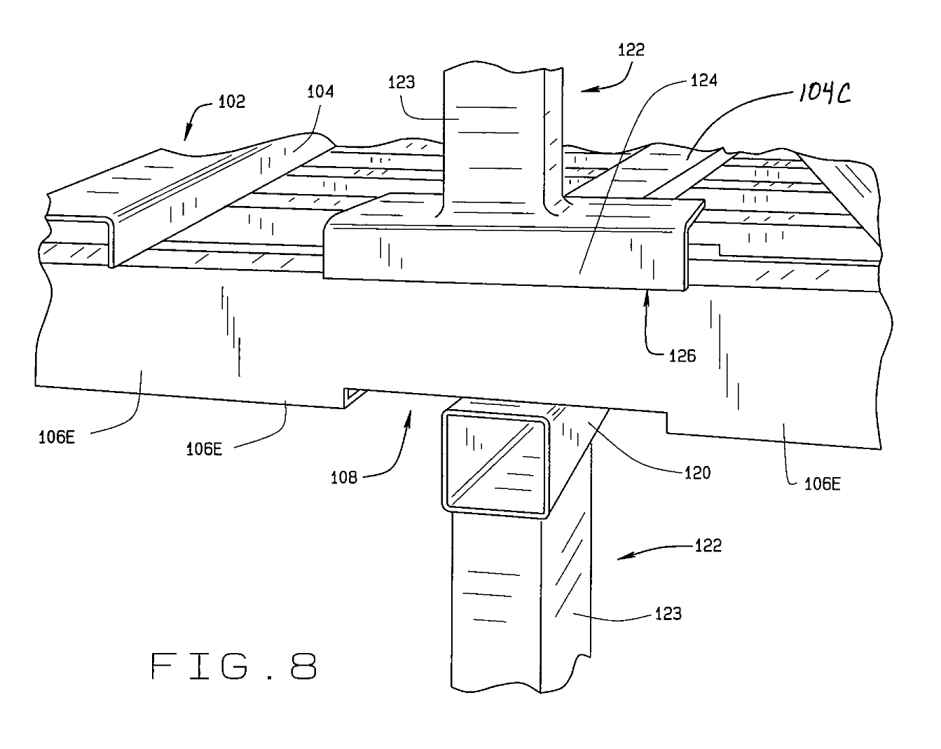

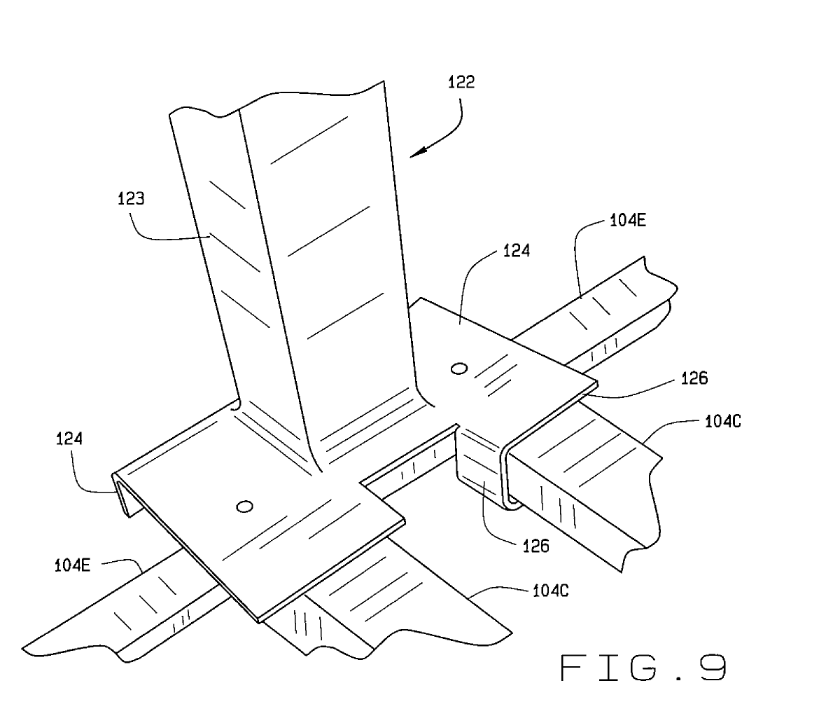

The method also includes assembling a stacking frame 122A on the first pallet assembly 100A with each leg 123 of the stacking frame 122A being positioned proximate to a center of each edge and each end of the first pallet assembly 100A. This includes inserting a toe 126 of two of the feet 124 of the stacking frame 122A into the notch 110 on the lower edge of the ends of the upper deck 102. An example of this is illustrated in FIGS. 6 and 7. A toe 126 of two of the other feet 124 of the stacking frame 122A are engaged or positioned under a coupling deck board 104C of the upper deck 102 of the first pallet assembly 100A. An example of this is illustrated in FIGS. 8 and 9. The method further includes placing a second pallet assembly 100B onto an upper portion 120 of the stacking frame 122A that is assembled on the first pallet assembly 100A. The second pallet assembly 100B can include the same features as the first pallet assembly 100A or can be of another configuration and design. A first upper portion 120 of the stacking frame 122A is positioned into the notches 118 in the bottom of the two support members 114 as shown in FIGS. 6 and 7. A second upper portion 120 is positioned into the notches on the lower surface of the stringers 106 as shown in FIGS. 8 and 9. In some embodiments, such a placement of stacking frame 122A into the notches 108 on the underside of the stringers 106 and the support members 114 can provide for restricting and/or eliminating slippage or movement there between and therefore also between an upper pallet assembly 100B and a lower pallet assembly 100A.

In some embodiments, the method can include stacking a third pallet assembly 100C onto the top of the second pallet assembly 100B and building a higher vertical stack of pallets. This can include assembling an upper stacking frame 122B on the second pallet assembly 100B with each leg of the upper stacking 122 frame being positioned proximate to a center of each edge and each end of the second pallet assembly 100B and inserting a toe of two of the feet 124 of the upper stacking frame 122B into a notch 110 on the lower edge of the ends of an upper deck 102 of the second pallet assembly 100B. A toe 126 of the other foot 124 of the upper stacking frame 122B can be inserted under or otherwise engage with a coupling deck board 104C of the upper deck 102 of the second pallet assembly 100B. A third pallet assembly 100C is then placed onto the upper portion 120 of the upper stacking frame 122B that is assembled on the second pallet assembly 100B. The third pallet assembly 100C being the same as the first and second pallet assemblies 100A and 100B, respectfully. This can include positioning a first upper portion 120 of the upper stacking frame 122 into notches 118 in the bottom of two support members 114 of the second pallet assembly 100B and positioning a second upper portion 120 of the upper stacking frame 122B into notches 108 on the lower surface of stringers 106 of the third pallet assembly 100C.

Additional levels of stacking frames 122 and pallet assemblies 100 are possible to add additional vertical height and storage per square feet of storage area using additional iterations of this method. As known to those skilled in the art, such arrangements as provided and described by way of example herein can provide such vertically built stacking frames 122 and pallet assemblies 100 with the advantage over other arrangements as the weight of each successive vertically built pallet assembly 100 and its load are support by the stacking frames 122 and the stringers 106 and support members 114 and not by the upper deck 102 or a lower deck 128 where applicable.

One skilled in the art can identify some of the uses and benefits made available by various embodiments of the pallet assembly as describe by this disclosure. This can include improved safety and operation of stacked pallets in a warehouse or during transportation especially when multiple pallets are stacked in a tier. This can reduce costs due to spoilage and reduce cost due to injury of personnel. This can include restricting or limiting slippage during static placement of the tiered pallets in a warehouse, truck, storage hold of a ship, a shipping container or otherwise and can also provide for the ability for moving a tier of pallets via a fork lift or other lifting and moving device. The pallet assemblies as described herein provide for securing of a wide variety of pallet stacking frames on a pallet assembly that provide for improved support for stacking frames and the weight carried by such stacking frames. Some embodiments of the disclosure provide for a transfer of weight from an upper stacking frame to a lower stacking frame without an intervening deck board or upper deck portion of the pallet assembly having to support and transfer the weight. Additionally, some embodiments of the disclosure also provide for improved anti-slipping and anti-sliding coupling between a lower stacking frame and the pallet and between an upper stacking frame and the pallet including during movement of the tiered pallets as a unit. Some or all of these and other benefits are possible by the various exemplary embodiments of this disclosure and the broader scope of the claims.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A pallet assembly for use with a stacking frame comprising:
an upper deck for receiving material to be held by the pallet assembly, the upper deck defining two opposing edges and two opposing ends, the ends of the upper deck including at least one notch along a lower edge dimensioned for receiving a toe of a stacking frame positioned above the upper deck;
a plurality of stringers extending a length of the upper deck, each stringer having an elongated body with two ends, a central portion, an upper surface, a lower surface, and a notch along the lower surface about the central portion, the plurality of stringers including an edge stringer on each of the two opposing edges of the upper deck, and two intermediate stringers positioned apart and on opposing sides of a midpoint between the two edges; and
a support member positioned beneath the upper deck between the two intermediate stringers and an end of the upper deck, the support member having a column extending upwardly for engaging a portion of the upper deck and a notch along a bottom surface.

2. The assembly of claim 1 wherein the upper deck includes a plurality of deck boards including an end deck board on each end and two coupling deck boards positioned proximate to the notch of the stringers.

3. The assembly of claim 2 wherein each end deck board includes at least one notch.

4. The assembly of claim 1 wherein each end deck board includes a pair of notches spaced apart by an intervening portion and the center column of the support member is engaged with the intervening portion and between the two notches.

5. The assembly of claim 4 wherein the pair of notches are configured for receiving a pair of toes of a foot of a stacking frame and at least partially securing the foot of the stacking frame to the upper deck.

6. The assembly of claim 2 wherein each deck board includes a pair of notches.

7. The assembly of claim 2 wherein the two coupling deck boards have a width less than a width of the end deck boards and are positioned on opposing sides of a center line of the stringers and are configured to support a foot of a stacking frame and receive a toe of the stacking frame for at least partially securing the foot of the stacking frame to the upper deck.

8. The assembly of claim 1 wherein the notch of the support member is dimensioned for receiving an upper portion of a stacking frame positioned below the pallet assembly.

9. The assembly of claim 8 wherein the notches along the lower surface of the stringers are dimensioned for receiving a second upper portion of the stacking frame positioned below the pallet assembly.

10. The assembly of claim 9 wherein the notches in the stringers form a channel for receiving the second upper portion of the stacking frame between the two edges of the upper deck.

11. The assembly of claim 1 wherein there are two support members, one positioned on each end of the upper deck and wherein the notches of the two support members forms an unobstructed channel from one end to the other end, further comprising a lower deck beneath and parallel to the upper deck and attached to the stringers, the lower deck configured to not obstruct the channel formed by the notches of the two support members.

12. The assembly of claim 1, further comprising a pair of lower end members positioned on each end, wherein each of the lower end members is attached to one of the edge stringers and one of the intermediate stringers.

13. The assembly of claim 1 wherein upper deck, stringers and the support member are each composed of a metal and where each is coupled to another by a weld.

14. The assembly of claim 13 wherein the stringers and the support member are configured from box channels and the upper deck is configured from a metal portion selected from the group consisting of a plurality of c-channels and a plurality of box channels.

15. The assembly of claim 1 wherein the support member is configured to transfer weight from the upper deck to a stacking frame positioned in the notch of the support member and positioned below the assembly.

16. The assembly of claim 15 wherein the support member is configured to transfer weight from a stacking frame positioned above the upper deck that is coupled in the notch of the upper deck to the stacking frame positioned below the upper deck.

17. The assembly of claim 1 wherein one or more of the stringers are notched for receiving a fork from a lifting device.

18. A method of assembling a pallet comprising:
forming a plurality of upper deck boards from metal c-channel;
cutting two notches on a lower edge proximate to the center of two of the upper deck boards to form two end deck boards, the two notches being separated by an intervening portion:
forming a plurality of stringers from metal box-channel including cutting a notch in each stringer on a lower surface of each stringer, the plurality of stringers including two edge stringers and two intermediate stringers;
forming two support members from metal box-channel including forming an upwardly extending column proximate to a center of each support member and cutting a notch on the bottom surface of each support member;
placing each upper deck board parallel to each other and each stringer perpendicular to each upper deck board with an edge stringer positioned at each end of each deck board and the two intermediate stringers positioned on opposing sides of a middle of each deck board;
welding each stringer to each upper deck board;
welding each support member proximate to each end of the intermediate stringers; and
welding the column of each support member to the two intervening portions between the two notches on the lower edge of the two end deck boards.

19. The method of claim 18, further comprising welding a lower end member at each end between each edge stringer and the adjacent intermediate stringer.

20. A method of stacking a plurality of pallets using stacking frames, the method comprising:
placing a first pallet assembly on a floor, the first pallet assembly having an upper deck having a plurality of deck boards including two coupling deck boards, a plurality of stringers extending a length of the upper deck, each stringer having an elongated body with two ends, a central portion, an upper surface, a lower surface, and a notch along the lower surface about the central portion, the plurality of stringers including an edge stringer on each of the two opposing edges of the upper deck, and two intermediate stringers positioned apart and on opposing sides of a midpoint between the two edges, and two support members positioned beneath each end of the upper deck and between the two intermediate stringers, each support member having a column extending upwardly for engaging a portion of the upper deck and a notch along a bottom surface;
assembling a stacking frame on the first pallet assembly with each leg of the stacking frame being positioned proximate to a center of each edge and each end of the first pallet;
inserting a toe of two of the footplates of the stacking frame into a notch on the lower edge of the ends of the upper deck;
engaging a toe of two of the other footplates of the stacking frame under a coupling deck board of the upper deck of the first pallet assembly; and
placing a second pallet assembly onto an upper portion of the stacking frame that is assembled on the first pallet assembly, the second pallet assembly being the same as the first pallet assembly, wherein placing includes positioning a first upper portion of the stacking frame into the notches in the bottom of the two support members and positioning a second upper portion of the stacking frame into the notches on the lower surface of the stringers.

21. The method of claim 20 wherein the stacking frame is a lower stacking frame, further comprising:
assembling an upper stacking frame on the second pallet assembly with each leg of the upper stacking frame being positioned proximate to a center of each edge and each end of the second pallet;
inserting a toe of two of the footplates of the upper stacking frame into a notch on the lower edge of the ends of an upper deck of the second pallet assembly; and
engaging a toe of two of the other footplates of the upper stacking frame under a coupling deck board of the upper deck of the second pallet assembly; and
placing a third pallet assembly onto an upper portion of the upper stacking frame that is assembled on the second pallet assembly, the third pallet assembly being the same as the first and second pallet assemblies, wherein placing includes positioning a first upper portion of the upper stacking frame into notches in the bottom of two support members of the second pallet assembly and positioning a second upper portion of the upper stacking frame into notches on the lower surface of stringers of the second pallet assembly.
